(19) United States
(12) Patent Application Publication
(10) Pub. No.: US 2006/0207822 A1
(43) Pub. Date: Sep. 21, 2006

(54) Differential steering application for trailer spotter vehicles

(76) Inventor: Kermit O. Taylor, Fort Wayne, IN (US)

Correspondence Address: BAKER & DANIELS LLP;111 E. WAYNE STREET, SUITE 800, FORT WAYNE, IN, 46802, US

(21) Appl. No.: 11/340,086

(22) Filed: Jan. 26, 2006

Related U.S. Application Data
(60) Provisional application No. 60/647,481, filed on Jan. 27, 2005.

(51) Int. Cl. B62D 11/02

(52) U.S. Cl. 180/326; 180/6.58

(57) ABSTRACT

A trailer spotter vehicle having a seat and a control console which are relatively rotatable with respect to the vehicle frame, and a differential drive system which permits the vehicle to turn within a very small turning radius. The rotatable seat and control console allow the operator to steer the vehicle without having to substantially turn their body or use mirrors to observe the path of the vehicle. To drive the vehicle in a forward direction, hydraulic pumps transmit pressurized hydraulic fluid to the trailer spotter wheels to rotate them in a first direction. In order to drive the vehicle in reverse, the flow of hydraulic fluid to the wheels is reversed to rotate the wheels in an opposite direction. To pivot the vehicle, the first wheel is driven in the first direction and the second wheel is driven in the opposite direction.

### BACKGROUND OF THE INVENTION

1. Field of the Invention

The present inventive concept relates to differential drive systems for a vehicle serving as a trailer spotter for semi-trailers or drawbar-type trailers, especially in off-highway environments such as freight terminals, ports, rail yards, warehouses, and factories.

2. Description of the Related Art

When over-the-road semi-tractors and trailers came into use, the over-the-road semi-tractors were also used to reposition the trailers in freight yards. On average, the time to reposition a trailer in the freight yard required approximately eighteen minutes. Within a few years, non-over-the-road specialized tractors were developed to reduce this time to about twelve minutes. These specialized tractors utilized two features to provide customer value compared to their predecessors—a elevating fifth wheel hitch and a smaller engine. The ability to raise the fifth wheel enabled operators to move trailers without retracting the trailer's landing gear, saving time and effort. The smaller engine reduced fuel consumption costs.

Owing to size limitations of these specialized tractors, the cabs were usually mounted on top of the vehicle frame. Ergonomically, this meant that the operator was unnecessarily climbing up and down stairs for an extra hundred feet every day. Although low forward entry cabs were known, these cabs required the vehicle to be longer in order to utilize such a cab. Due to the requirement for tight maneuverability for yard spotters, this additional length was not normally acceptable and, as a result, these specialized tractors did not benefit from a low forward entry cab.

Further, these specialized tractors included a door in the cab that facilitated an operator's ingress into and egress out of the cab via a deck on the tractor in front of the trailer hitch. However, opening and closing the door every time the operator stepped onto the deck slowed them down and gradually added to their fatigue. As a result, the operators often removed the vehicle's rear door during summer months in order to ease their workload. Accordingly, not only did the operators spend labor hours removing and reinstalling the door, but by the time they went looking for the door in the fall, the door was often damaged or lost resulting in increased maintenance costs to their employer.

The specialized tractors discussed above, commonly called trailer spotters, have existed for approximately fifty years without significant technological improvement. To date, trailer spotters have utilized a conventional truck frame, a reduced-size traditional-style cab, and a standard drive system having an engine, a transmission, a driveshaft, and a differential for relaying power to a pair of drive wheels via a set of axles. Since most trailer spotters do not require the power to achieve highway speeds, do not climb grades, and do not include the full size or sleeper cabs, they are smaller, more maneuverable, and utilize a lower horsepower engine. For example, current trailer spotters typically utilize engines having between 150-225 horsepower, as compared to fleet trucks which utilize engines having between 300-600 horsepower. As a result, the benefit of a trailer spotter is generated through the reduced time to relocate a trailer around a dock or yard while consuming less fuel than their over-the-road counterparts.

A drawback to current trailer spotters includes the standard truck drive train utilized by these trailer spotters. These standard truck drive trains include front wheels for steering the vehicle according to the Ackerman steering principle and rear wheels for driving the vehicle. As a result, the mobility of current trailer spotters is typically limited to a minimum turning radius of approximately 36 feet. This is depicted in FIG. 1, which was substantially taken from SAE Recommended Practices J695. Steering systems of this type include many linkages, springs and shock absorbers, power assist units, and adjustments for alignment. The turn radius of these vehicles is limited by the extent of travel in these linkages and the fact that the drive wheels do not contribute to the turning function. As a result, maneuvering the tractor and trailer will either scribe a smooth arc over a large area, an unfeasible business expense, or a serpentine course, involving multiple steering adjustments and effort, in a somewhat smaller space. The difficulty of performing these maneuvers accurately has caused many users to remove the higher speed gears from the stock transmissions to improve safety and reduce damage when parking trailers inches apart in the yard. Additionally, these limitations in maneuverability have recently been exacerbated by longer trailers in service and increases in freight to be handled without corresponding increases in yard space, particularly in established city facilities. Some users have attempted to circumvent the these problems by using two or more shorter trailers coupled together by wheeled dollies while traveling between freight terminals, then breaking these ‘bob-tail trains’ down for maneuvering inside the yard or city. This returns the trailer maneuver difficulty level to previous standards but doubles the number of trips required to reposition all of the trailers.

Further, the operation of a trailer spotter requires an unending series of sudden stops and starts, impact loads, and direction changes. This results in wear on the mechanical drive train, despite the selection of heavy duty components. As a result, even with a good maintenance program, vehicle service life seldom extends beyond fifteen years. Further, in order to keep the costs of the truck spotters down, conventional truck transmissions are typically modified to omit gear synchronization systems, thereby requiring operators to have special training. In addition, traditional drive train positioning is constrained by the size of the engine and transmission and the amount of misalignment that can be handled by universal joints at the ends of the driveshaft. Consequently, the engines and transmissions have all been located near the vehicle center line at the front of the vehicle. This positioning limits cab design options and results in little weight over the drive wheels. The lack of weight over the drive wheels is not necessarily important when towing a trailer mounted on the fifth wheel attachment, but it significantly decreases drawbar pull when attempting to tow other types of trailers.

Another instance where existing trailer spotters lack optimization is the operator interface. When moving fifth wheel trailers using existing trailer spotters, the tractor operator must rely on mirrors and/or twist their body/head to the rear to view the trailer. Reliance on mirrors restricts the operator's field of view and forces the operator to work with a flipped image, i.e., turning the opposite direction from what they see in the mirror. Also problematic, turning or twisting to see the trailer impedes the operator's ability to turn the steering wheel. As a result, both techniques slow their performance and complicate their tasks. These problems occur as a result of the typical mechanical linkages between the operator interface and the vehicle steering and transmission systems which dictate that the driver's seat and control console be fixed in one direction, the typical direction being forward. However, in some embodiments, when the work was off the back of the vehicle, as in backhoes, the seat could be rotated so that the operator may view the work directly. In these previous vehicles, though, the control console did not rotate with the seat and, as a result, an additional control console was required thereby adding cost to the vehicle.

From the above information, it is apparent that the prior art trailer spotter vehicles are far from optimized. However, although freight handling managers have been complaining about inability to keep up with demand, trailer spotter manufacturers have not envisioned the potential enhancements to their product line discussed below.

### SUMMARY OF THE INVENTION

The present invention includes a trailer spotter vehicle having a seat and a control console which are relatively rotatable with respect to the vehicle frame. The trailer spotter vehicle further includes a differential drive system. The differential drive system permits the vehicle to turn within a very small turning radius while the rotatable seat and control console allow the operator's seat and control console to be positioned such that an operator may steer the vehicle without having to substantially turn their body or use mirrors to observe the path of the vehicle.

In one embodiment, the differential drive system includes an engine and first and second hydraulic pumps driven thereby. The first and second hydraulic pumps provide hydraulic fluid to first and second hydraulic motors which are mechanically engaged with first and second ground-engaging wheels, respectively, mounted to the frame of the trailer spotter vehicle. To drive the vehicle in a forward direction, the hydraulic pumps transmit pressurized hydraulic fluid to the motors to drive the wheels in a first direction. In order to drive the vehicle in reverse, the flow of hydraulic fluid to the motors is reversed to rotate the wheels in a direction opposite the first direction. To pivot the vehicle, the first wheel can be driven in the first direction and the second wheel can be driven in the opposite direction in order to substantially turn the vehicle about an axis. Advantageously, the trailer spotter vehicle can be more easily maneuvered than previous trailer spotters.

The use of differential steering enables the tractor to sharply pivot under a fifth wheel mount between the trailer spotter vehicle and a trailer mounted thereto, or pivot about a point between or near the drive wheels, wherein, as a result, the turning radius is not substantially larger than the wheel base. This design may reduce the tractor's wall-to-wall turning diameter by more than half, but, even more remarkably, as illustrated in FIG. 3, it enables the trailer to be rotated about its rear axle and be backed into a slot/dock position with minimal maneuvering space and effort. Typically, as a result, this improvement in maneuvering can reduce the time required to position a trailer from an average of about 12 minutes to about 8 minutes. Further, the reduction in required maneuvering space will enable more trailers to be stored in a yard, thereby resulting in a corresponding increase in storage capacity. The improved maneuverability of the trailer spotter may also result in less damage to the trailers by making it easier for the operators to adjust the vehicle's position.

Further, differential steering, as described above, allows the linkages, springs, and power assists of the previous front-wheel steer systems to be replaced with two caster wheels. Eliminating these components may reduce the overall vehicle weight by approximately 2,000 pounds. Further, as the differential drivetrain can be effected by hydraulics, as described above, the engine can be relocated toward the rear of the vehicle, thereby lightening the weight of the front end of the vehicle and permitting the use of smaller tires which will swivel more easily. Accordingly, in one embodiment, the rear axle is expected to bear about 6,000 pounds of the vehicle's weight, which is approximately half again as much as existing trailer spotters, which will result in a 50% increase in draw-bar trailer towing capacity. In this embodiment, the improved draw-bar pull capacity will theoretically enable the trailer spotter to tow three loaded multi-axle trailers or doubles trailers across a flat gravel surface. This versatility is helpful in the worldwide marketplace, as fifth wheel trailers are less common outside the major industrialized countries.

In one embodiment, the use of electronic controls enables the control console to be rotated with the operator's seat to, as described above, allow the operator to directly view the work to be performed while operating the controls. The ability for the operator to directly view the work, coupled with the vehicle's enhanced mobility, may speed job completion, reduce trailer damage rates, and enhance safety. Further, electronic controls may provide for integration of vehicle speed and steering commands for nearly instantaneous responsiveness, and provide adaptable motion resistance to reduce operator fatigue. Further, as an electronic control system uses a minimal number of mechanical systems, there are less components to accumulate wear and tolerances. Further, owing to the electronically controlled hydrostatic drive, unlike trucks with mechanically geared transmission systems, the vehicle engine of the present embodiment can be set for optimum horsepower, fuel efficiency, or maximum torque as the operator deems necessary for the work performance. Advantageously, controlling the engine in this way can provide full power at lower speeds, stable engine RPM for minimum wear, and conserve energy. As a result of the improved drive train efficiency, a lower horsepower engine may be utilized to yield an approximately 20% improvement in fuel savings in one embodiment. Further, as a result of the electronic controls, the steering, brake, and accelerator controls can move independently of terrain or mechanical linkage resistance, and thus they can be designed to reduce operator effort while retaining functionality.

In one embodiment, to facilitate an operator's ingress into and egress from the trailer spotter cab, the cab can include a main entry door in the front of the cab. Manufacturers of farm tractors have previously positioned two doors in the front corners of their vehicles. However, these doors did not incorporate the vehicle windshield nor span the direct frontal area, or centerline, of the vehicle. In embodiments of the present invention utilizing a hydraulic drive train that has been placed at the rear of the vehicle, a low forward entry cab design, in combination with a lower front door, can be utilized. Ultimately, the door location, along with the rotatable seat and control console, minimizes operator fatigue and improves operator efficiency.

In one embodiment, the cab of the trailer spotter further includes a rear door for entering the cab. In this embodiment, the rear door of the cab can slide inboard on tracks to be stored along the interior sidewall of the cab. In this embodiment, the rear door is designed such that, when the rear door and sidewall are side-by-side, the rear door window substantially aligns with the window in the sidewall so as to not obstruct the operator's vision, thereby allowing the operator to maintain the same level of awareness whether the rear door is open or closed. The rear door, in this embodiment, is conveniently stowed inside of the trailer and is less susceptible to damage or being lost.

The present invention provides a dramatic enhancement in trailer spotter maneuverability, vehicle simplification, improved vehicle versatility through changes in weight distribution, enhanced safety, and reduced probability of trailer damage.

### BRIEF DESCRIPTION OF THE DRAWINGS

The above-mentioned and other features and objects of this invention will become more apparent and the invention itself will be better understood by reference to the following description of an embodiment of the invention taken in conjunction with the accompanying drawings, wherein:

FIG. 1 is a schematic depicting the steering characteristics of a prior art trailer spotter vehicle;

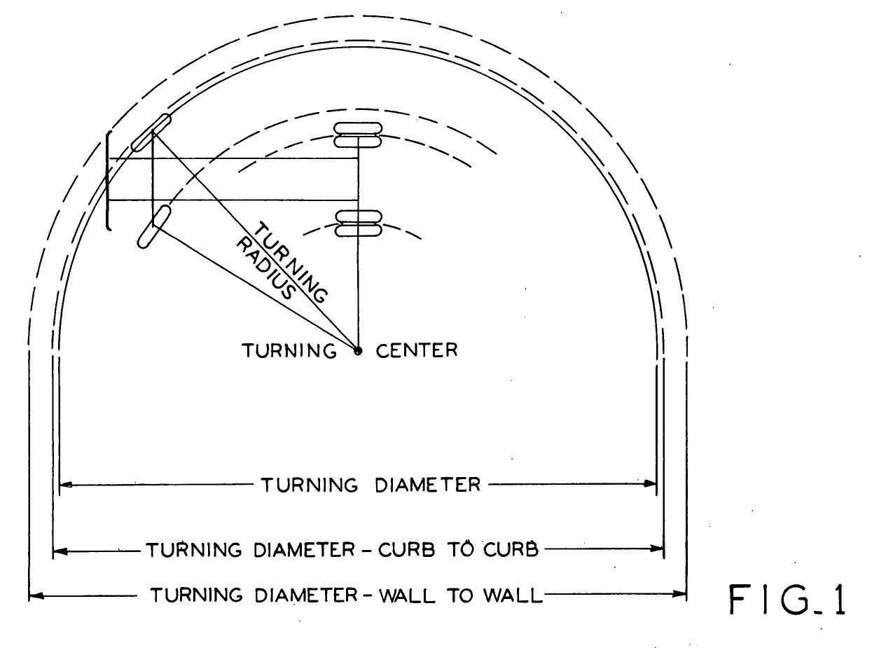

FIG. 2 is a schematic depicting the maneuverability of the prior art trailer spotter of FIG. 1 having a trailer attached thereto;

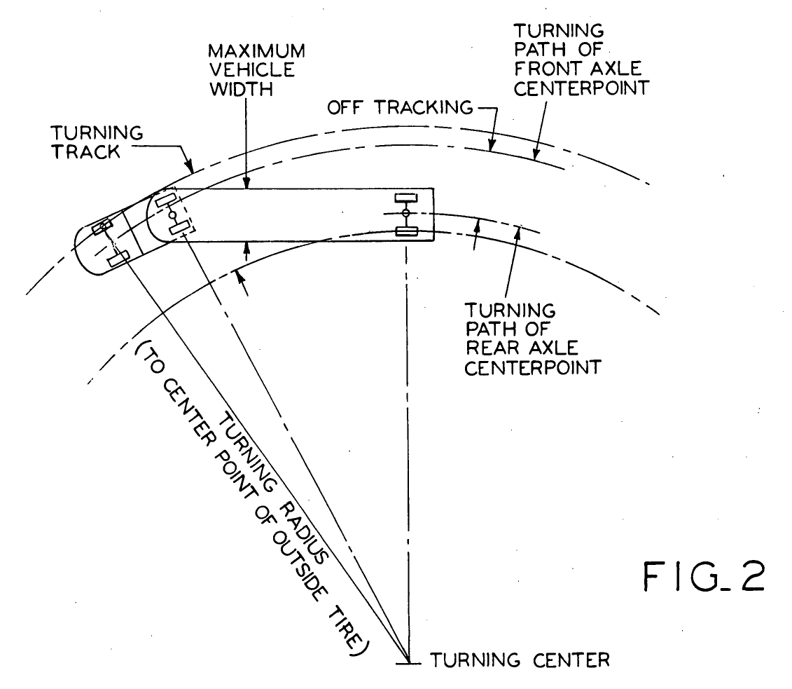

FIG. 3 is a schematic depicting the maneuverability of a trailer spotter in accordance with an embodiment of the present invention having a trailer attached thereto;

FIG. 4 is a perspective view of a trailer spotter in accordance with an embodiment of the present invention;

FIG. 5 is a side view of the trailer spotter of FIG. 4;

FIG. 6 is a diagram of the hydraulic differential powertrain of the trailer spotter of FIG. 4;

FIG. 7 is a perspective view of the front caster wheel mount assemblies of the trailer spotter of FIG. 4;

FIG. 8 is a perspective view illustrating hidden features of the front caster wheel mount assemblies of the trailer spotter of FIG. 4;

FIG. 9 is a partial cutaway view of the cab of the trailer spotter of FIG. 4 illustrating the operator's chair in a forward position;

FIG. 10 is a partial cutaway view of the cab of the trailer spotter of FIG. 4 illustrating the operator's chair in a rearward position;

FIG. 11 is an elevational view of an operator's chair in accordance with an alternative embodiment of the present invention;

FIG. 12 is a perspective view of an operator's chair in accordance with a further alternative embodiment of the present invention;

FIG. 13 is a control diagram for trailer spotter of FIG. 4 illustrating a programmable controller interconnecting the control console and the hydraulic powertrain of the trailer spotter of FIG. 4;

FIG. 14 is a schematic of ajoystick for steering the trailer spotter of FIG. 4;

FIG. 15 is a table illustrating the speed of the trailer spotter wheels and hydraulic pump output for positions of the joystick of FIG. 14;

FIG. 16 is a perspective view of the anti-jackknifing system of the trailer spotter of FIG. 4;

FIG. 17 is an elevational view of the anti-jackknifing system of FIG. 16;

FIG. 18 is a partial cutaway view of the switch box of the anti-jackknifing system of FIG. 16;

FIG. 19 is a front view of the trailer spotter of FIG. 4 with the front door of the cab removed; and

FIG. 20 is a perspective view of the rear door assembly of the trailer spotter of FIG. 4.

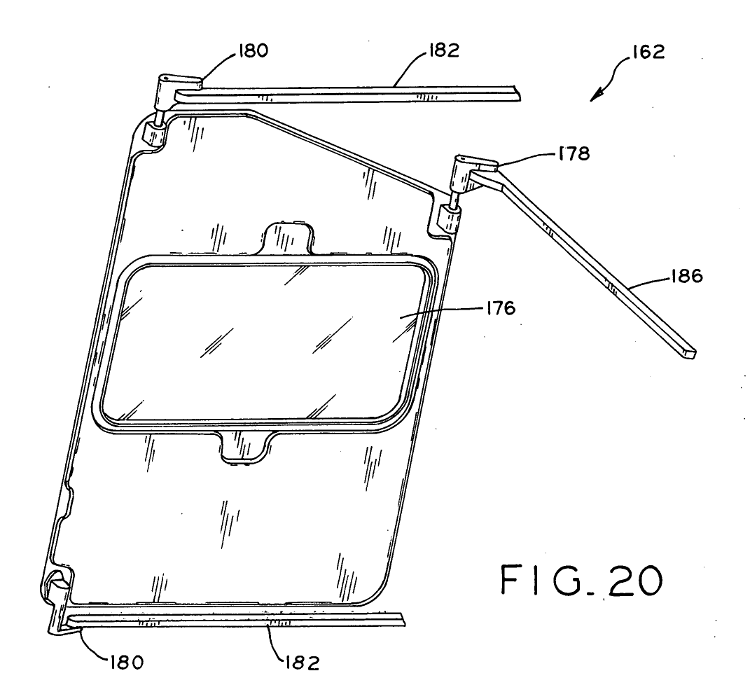

Corresponding reference characters indicate corresponding parts throughout the several views. Although the exemplifications set out herein illustrate embodiments of the invention, the embodiments disclosed below are not intended to be exhaustive or to be construed as limiting the scope of the invention to the precise form disclosed.

### DETAILED DESCRIPTION

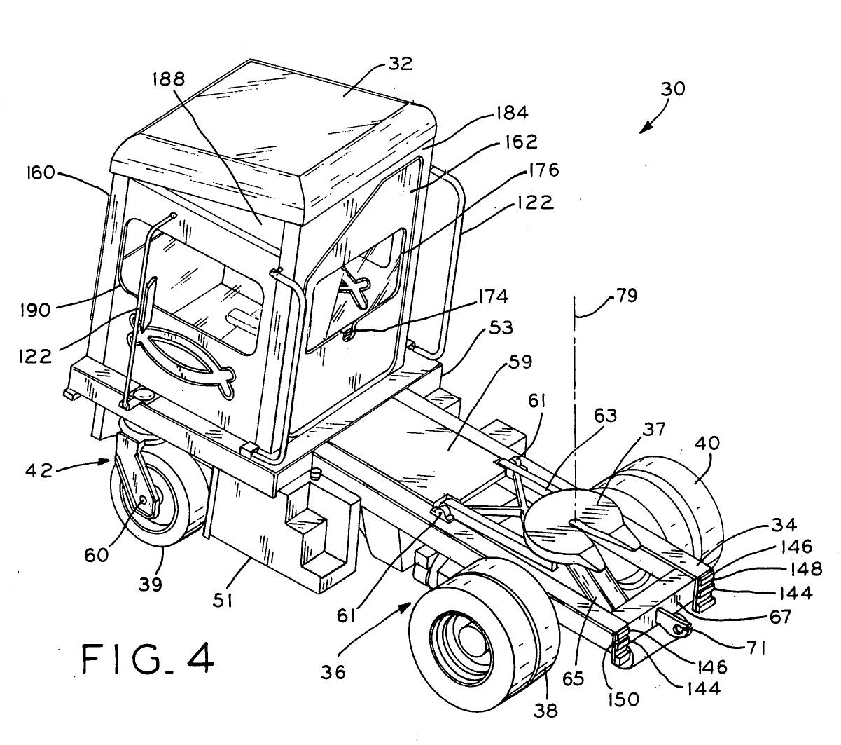

Referring to FIGS. 4-6, trailer spotter 30 of the present invention includes cab 32 and frame 34. Trailer spotter 30 further includes differential drive system 36 mounted to frame 34 which is operatively engaged with left rear wheels 38 and right rear wheels 40. Frame 34 further includes an engine cradle which houses engine 39, multi-pump drive 41, variable displacement hydraulic pumps 43 and 45, hydraulic radiator 47 and turbocharger intercooler 49 of differential drive system 36. In operation, air flows through turbocharger intercooler 49 into engine 39 to facilitate combustion therein, as is known in the art. Trailer spotter 30 further includes fuel tank 51, for storing fuel for engine 39, and hydraulic tank 53, for storing hydraulic fluid for differential drive system 36.

Trailer spotter 30 further includes engine cover 59 mounted above engine 39. Engine cover 59 is rotatable about pillow block bearings 61 to provide access to engine 39. Engine cover 59, when it is in a closed position, also serves as a deck for an operator to stand on when entering and exiting cab 32. Bearings 61 also provide a pivot axis for fifth wheel lift rack 63. Fifth wheel lift rack 63 includes a mount, i.e., fifth wheel hitch 37, which can connect trailer spotter 30 to a type of trailer known as a fifth wheel trailer. Trailer spotter 30 further includes lift cylinder 65 which includes a first end mounted to lift rack 63 and a second end mounted to frame 34. In use, a cylinder rod of cylinder 65 can be extended and retracted with respect to the housing of lift cylinder 65 to raise and lower fifth wheel hitch 37. Trailer spotter 30 further includes tow pintle 71 mounted to crossmember 67 of frame 34 for towing a type of trailer known as a draw-bar type trailer. Trailer spotter 30 further includes trailer connections 69 which provide electrical, hydraulic and/or air connections for a trailer mounted thereto. In some embodiments, an additional set of trailer connections 69 are mounted to the rear of cab 32.

As briefly described above, differential drive system 36 includes engine 39, multi-pump drive 41, variable displacement hydraulic pumps 43 and 45, pressure relief valves 73, and hydraulic motors 75 and 77 which are operatively engaged with ground engaging wheels 38 and 40, respectively. Engine 39 is operably engaged with multi-pump drive 41 such that the rotational movement of the crankshaft of engine 39 is transmitted to a set of gears within pump drive 41. The gears of pump drive 41 are operably engaged with shafts mounted within hydraulic pumps 43 and 45. Each pump shaft engages an eccentric member within the hydraulic pumps which, when rotated, compress hydraulic fluid therein and discharge the hydraulic fluid into pressure relief valves 73. Pressure relief valves 73, as is known in the art, guard against the hydraulic fluid from being overpressurized by pumps 43 and 45 and thereby prevent the seals, fittings and/or hydraulic lines of differential drive system 36 from rupturing due to excessive stress. In one embodiment, the above-discussed gear ratio can be selected based on optimum engine and hydraulic pump settings. For example, in one embodiment, the RPM of a commercially-available Cummins engine, at peak horsepower, is 2300 RPM, however, in order to drive the hydraulic pumps at 3200-3300 RPM, a 1:1.4U gearbox is needed.

The hydraulic fluid then flows into hydraulic motors 75 and 77 which convert the flow of hydraulic fluid into rotational movement of motor shafts mounted therein. Motors 75 and 77 further include a pinion gear mounted to an end of each motor shaft, wherein the pinion gears are operably engaged with planetary torque hub gear reduction mechanisms 79. In this embodiment, the planetary gear reduction allows multiple gears to share the torque load and may fit into a smaller space than other direct gear drive systems while maintaining a very high efficiency for the drive train. To accommodate severe loads, gear reduction mechanisms 79 can include multiple gear sets. Owing to the difference in size between the gear set, or sets, in planetary mechanism 79, the speed of the motor shafts is reduced before the rotation of the motor shafts is transmitted to ground-engaging wheels 38 and 40. In the present embodiment, for every 26 revolutions of the motor shafts in motors 75 and 77, wheels 38 and 40 are turned through only one revolution. This particular gear ratio was selected to provide a desired balance between speed and torque for the present embodiment, however, in other embodiments, other gear ratios may be selected according to the needs of a particular application.

Pumps 45 and 47, as described in further detail below, are variable displacement pumps which pressurize hydraulic fluid in two separate circuits for independently driving left rear wheels 38 and right rear wheels 40. As a result, left rear wheels 38 and right rear wheels 40 can be driven at different speeds and/or in different directions with respect to each other. To drive the trailer spotter 30 in a forward direction, the hydraulic pumps 45 and 47 transmit a substantially equal flow rate of hydraulic fluid to rear wheels 38 and 40. As a result of the substantially equal flow rate, the shafts of motors 75 and 77 are turned at substantially the same speed and, as a result, wheels 38 and 40 are driven at substantially the same velocity. Accordingly, as wheels 38 and 40 are turned at substantially the same velocity, trailer spotter 30 is driven in a substantially linear, forward direction.

To turn trailer spotter 30 while moving in the forward direction, as described in further detail below, the rate at which hydraulic fluid is pumped to one of motors 75 and 77 is either reduced or increased with respect to the other motor to thereby turn one of wheels 38 and 40 faster than the other. For example, in this embodiment, hydraulic pumps 45 and 47 each include a swash plate that can be oriented to increase or reduce the outputs of hydraulic pumps 45 and 47. As is known in the art, the swash plates can be positioned in one of three ranges of angles. In a first range of angles, the pumps produce a flow of hydraulic fluid in a first direction and, in a second range of angles, the pumps produce a flow in the opposite direction. Alternatively, the swashplates can be placed in a flat, or neutral, position in which the hydraulic pumps are substantially incapable of pressurizing the hydraulic fluid as described above. For either of the first and second ranges of angles, the speed at which the hydraulic fluid is discharged from the pumps is determined by the orientation of the swash plates with respect to the neutral or flat position. More particularly, the greater the angle between the swashplate and the neutral position, the faster the discharge flow.

In order to turn the vehicle to the right as it is moving in the forward direction, for example, the flow rate of hydraulic fluid exiting pump 43 can be increased such that the speed of left rear wheels 38 exceed the speed of right rear wheels 40. Alternatively, the flow rate of hydraulic fluid exiting pump 45 can be reduced such that it is less than the speed of hydraulic fluid exiting pump 43. In either event, left rear wheels 38 are turned faster than right rear wheels 40 to turn the vehicle to the right. To drive the trailer spotter 30 in a rearward direction, the swashplates in pumps 45 and 47 are both positioned at an angle such that the flows of the hydraulic fluid exiting pumps 45 and 47 are reversed. Similar to the forward direction, the flow rates of hydraulic fluid entering into motors 75 and 77 are substantially equal and, as a result, wheels 38 and 40 are turned at substantially the same velocity. Also, similar to the above, to turn the trailer spotter while it is traveling in the reverse direction, the rate at which the hydraulic fluid is discharged from pumps 45 and 47 is altered such that one of rear wheels 38 and 40 is turned faster with respect to the other.

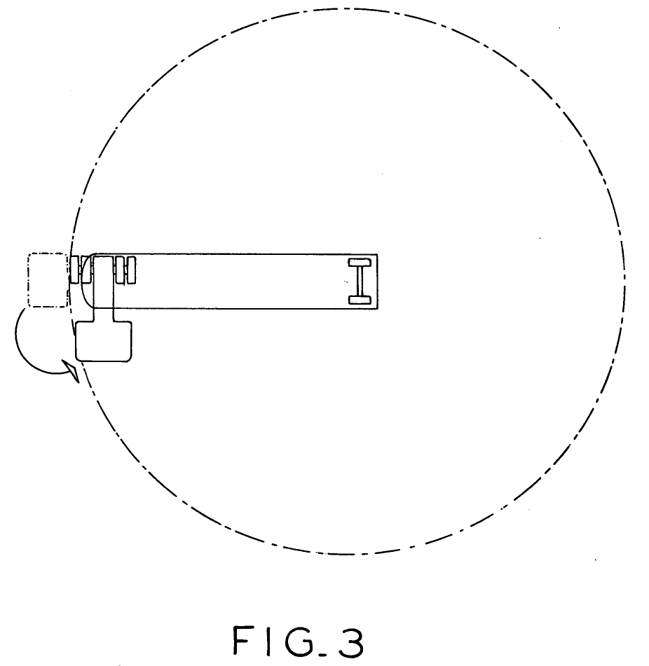

Alternatively, to pivot the trailer spotter 30 about an axis, the flow of hydraulic fluid exiting one of pumps 45 and 47 is reversed such that rear wheels 38 and 40 are turned in opposite directions. Accordingly, owing to these differentially driven wheels, trailer spotter 30 can rotate about a central axis, i.e., axis 79, which is substantially intermediate rear wheels 38 and 40. Accordingly, as trailer spotter 30 can rotate about axis 79, the speed at which the trailer spotter can be turned is substantially improved. Further, the maneuverability of the trailer spotter is greatly improved as it can be turned within a very tight turning radius. Additionally, differential drive train 36 allows the trailer spotter to swing about axis 79 and move trailers while driving perpendicular to the trailer, as illustrated in FIG. 3.

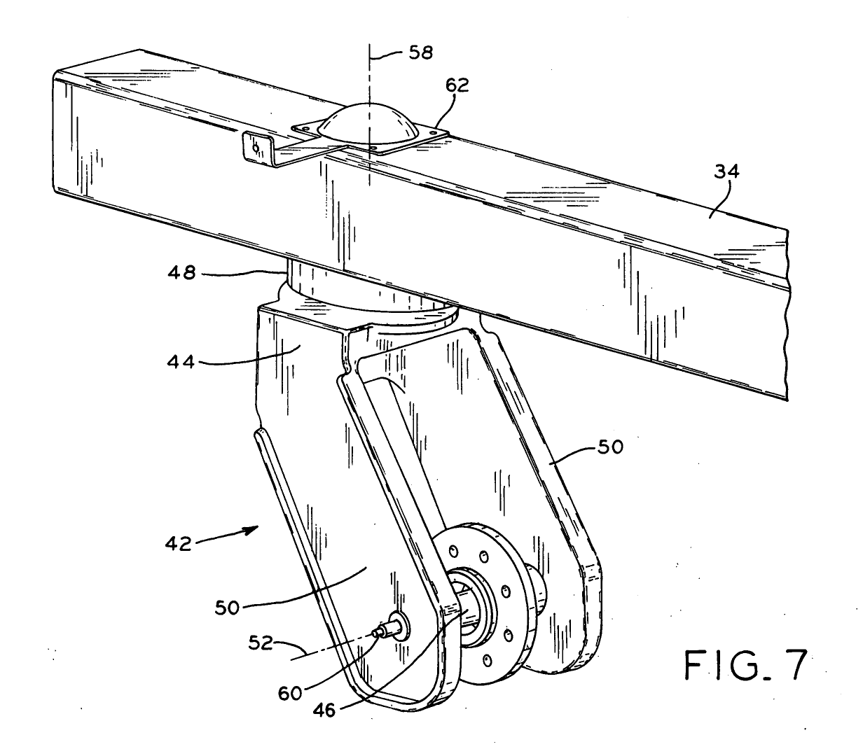

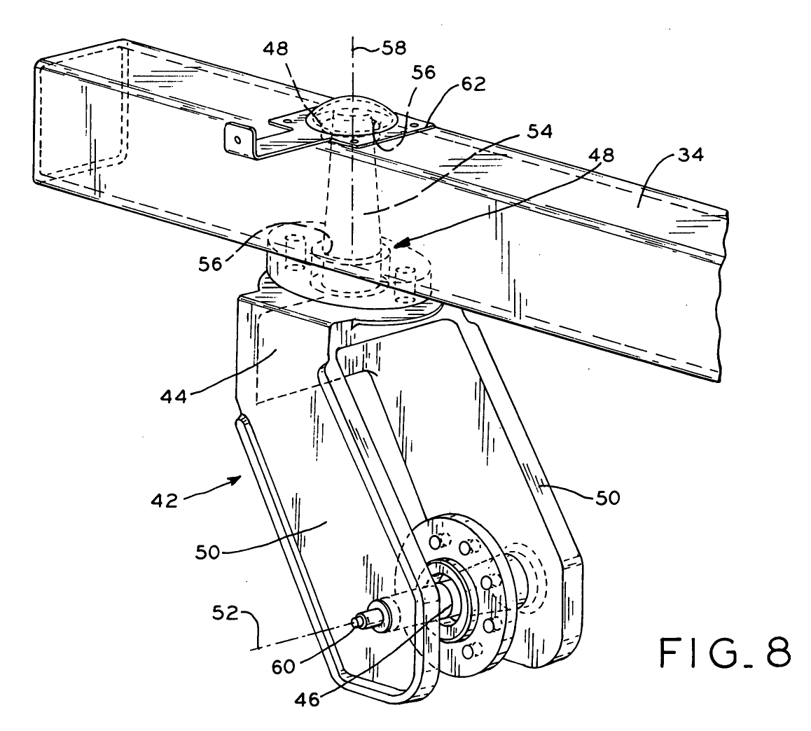

Referring to FIGS. 4-5 and 7-8, trailer spotter 30 further includes front wheels 39 which are mounted to frame 34 via caster wheel assemblies 42. Each caster wheel assembly 42 includes a bracket 44 having horizontal bearing 46 and two vertical bearings 48. Horizontal bearing 46 is trapped on non-rotating shaft 60 which extends through holes in bracket arms 50 and wheel 39. Wheel 39 is mounted to the outer race of horizontal bearing 46 such that wheel 39 is free to rotate with respect to the inner race of the bearing about axis 52. Wheel 39 is held in position between bracket arms 50 such that substantial relative translational movement between wheel 39 and bracket 44 is minimal. To facilitate the turning of trailer spotter 30, brackets 44 may rotate with respect to frame 34 via vertical bearings 48. More particularly, each bracket 44 includes a shaft member 54 rigidly mounted thereto which is configured to tightly receive the inner races of vertical bearings 48. The inner races of vertical bearings 48 are relatively movable with respect to the outer races of bearings 48 which are mounted within apertures 56 in frame 34. Referring to FIGS. 7 and 8, apertures 56 are located in opposite sides of the box tubing which comprises frame 34. In one embodiment, the box tubing of frame 34 is 8″ square tubing with ½″ thick walls, as opposed to ⅜-¼″ thick material on most trucks, which is thick and stiff enough to support the weight of the trailer spotter vehicle and the trailer loads mounted thereto.

Ultimately, shaft member 54 is configured to rotate within apertures 56 to permit relative rotational movement between bracket 44 and frame 34 about axis 58. However, although relative rotational movement is permitted between bracket 44 and frame 34, relative translational movement is substantially limited owing to the close fit between shaft member 54 and aperture 56. To assure that bracket 44 remains mounted to frame 34, the top vertical bearing 48 is flanged to overlap the opening in frame 34. Further, the end of shaft member 54 above the top vertical bearing 48 is threaded for receiving a castellated nut. In addition, cap 62 is placed over the top end of shaft member 54 to facilitate in keeping debris from entering into vertical bearings 48. Ultimately, the permitted relative rotational movement of wheels 39 about horizontal bearings 46 and brackets 44 about vertical bearings 48 allow wheels 39 to re-positioned themselves to facilitate, or at least not substantially inhibit, the movement of trailer spotter 30. To maintain the lubricity of the vertical bearings 48, the caster assemblies may further include a plastic insert positioned within frame 34 to serve as a grease reservoir or trap.

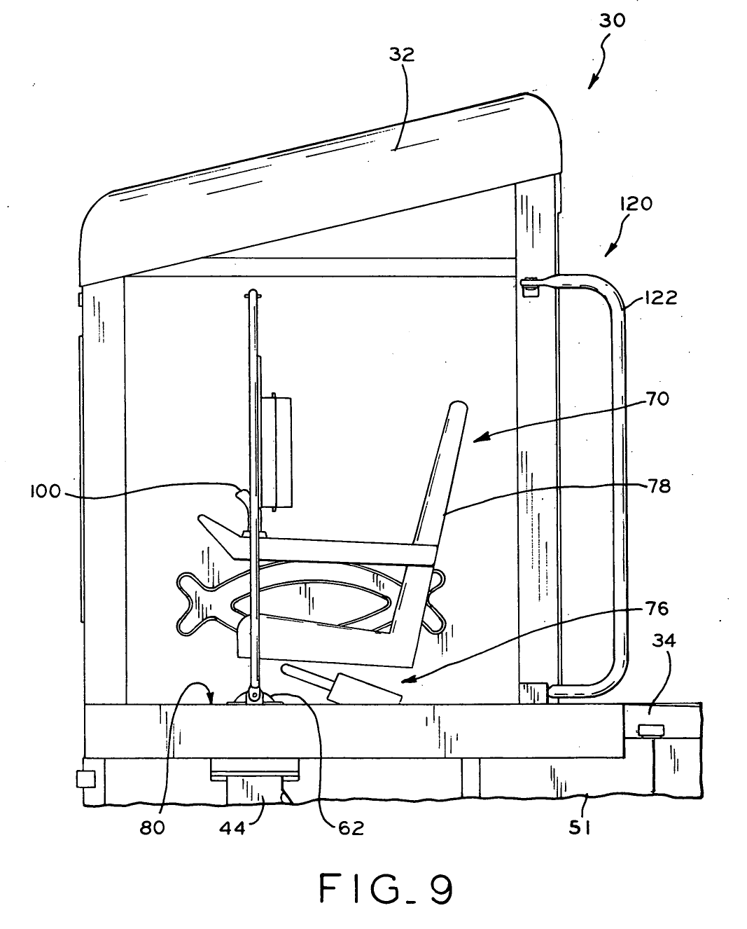

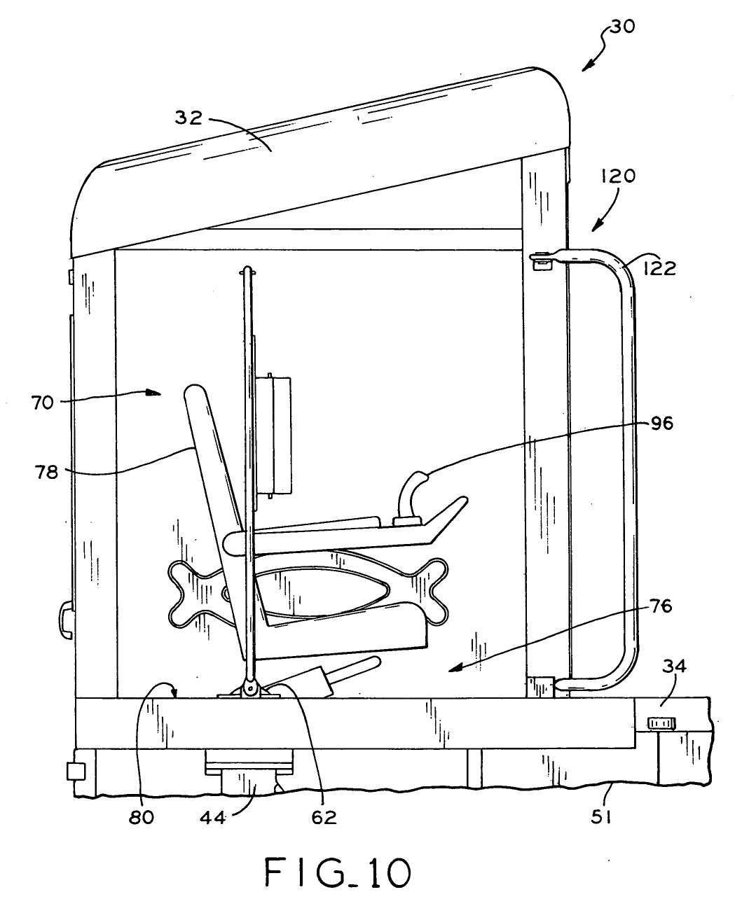

Referring to FIG. 9, trailer spotter 30 further includes chair 70 positioned within cab 32 for an operator to sit on while operating trailer spotter 30. In this embodiment, as described in further detail below, chair 70 can be rotated such that an operator sitting in the chair can position themselves in one of several different directions. For example, as illustrated in FIG. 9, chair 70 is facing forward so that an operator may easily look through the front window 72 whereas, as illustrated in FIG. 10, chair 70 is facing rearward so that the operator may easily look through the rear window 74. To accomplish this, chair 70 includes base portion 76 and chair portion 78 which is relatively rotatable with respect to base portion 76. More particularly, base portion 76 is mounted to floor pan 80 of cab 32 while chair portion 78 may turn with respect to base portion 76 via a bearing.

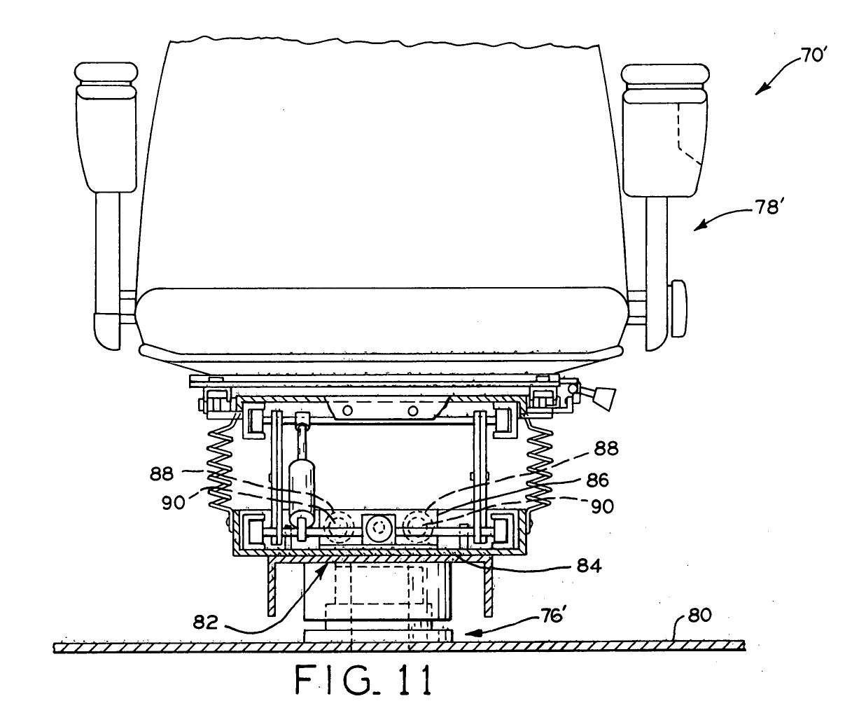

In an alternative embodiment, referring to FIG. 11, chair 70′ includes base portion 76′ mounted to floor pan 80 and bearing 82 positioned intermediate chair portion 78′ and base portion 76′. In this embodiment, bearing 82 includes two relatively movable members 84 and 86 mounted to base portion 76′ and chair portion 78′, respectively. Relatively movable members 84 and 86 define annular track 88 there between for receiving ball bearings 90. As is known in the art, ball bearings 90 facilitate the relative movement between base portion 76′ and chair portion 78′. Notably, the bearing of the chair is not limited to ball bearings, rather, in alternative embodiments, the chair may include other types of bearings. In the present embodiment, seat 56 further includes a pivot lock which comprises a pin that passes through an aperture (not illustrated) in seat portion 78′ and an aperture (not illustrated) in base portion 76′ to prevent substantial relative rotational movement between base portion 76′ and seat portion 78′. To permit the relative movement between base portion 76′ and seat portion 78′, the pin is disengaged from the aperture in base portion 76′. In the present embodiment, base portion 76′ has two apertures positioned on opposite sides thereof so as to receive the pin when the chair is facing in either of the forward and rearward directions. In other embodiments, base portion 76′ may include several apertures which permit seat portion 78′ to be locked into one of several different positions. In other embodiments, a spring-loaded latch, or other coupling devices, may be used in lieu of a lock pin.

Advantageously, a rotatable chair allows an operator to turn the chair so that may directly view the work being performed. This advantage is especially helpful in embodiments of the present invention which utilize a differential drive system, as described above. More particularly, owing to the improved maneuverability and responsiveness that a differential drive system provides, an operator may adjust their seat to view the path of the trailer spotter directly instead of having to observe the trailer spotter's path through mirrors and/or twist their body to see behind them. Accordingly, this allows for safer and more efficient operation of the trailer spotter.

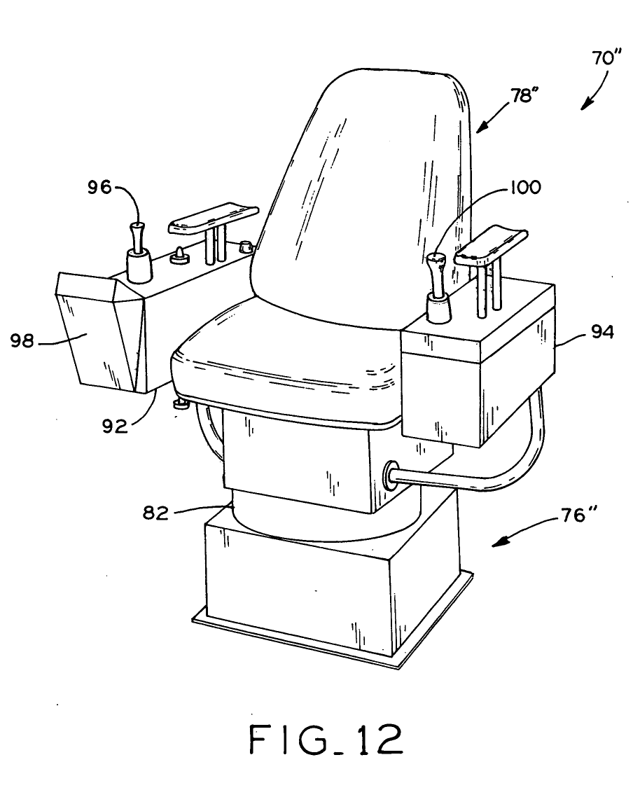

In an alternative embodiment, referring to FIG. 12, seat portion 78″ of chair 70″ includes controls mounted to armrests 92 and 94 for operating the trailer spotter. More particularly, armrest 92 includes joystick 96 which is operated to control the direction and speed of the trailer spotter vehicle. As discussed in further detail below, the trailer spotter vehicle includes a programmable controller which receives input signals from joystick 96 which, ultimately, are used to move the swash plates in hydraulic pumps 45 and 47 to adjust the flow of hydraulic fluid to rear wheels 38 and 40, as described above. Armrest 92 further includes switches for starting the engine, controlling the fifth wheel lift, activating the parking brake, and operating the auxiliary functions of the vehicle such as the lights and the windshield wipers, etc. Armrest 92 further includes console display 98 which displays the operating conditions of the trailer spotter. Armrest 94 includes the turn signal switches and brake joystick 100 for braking the vehicle.

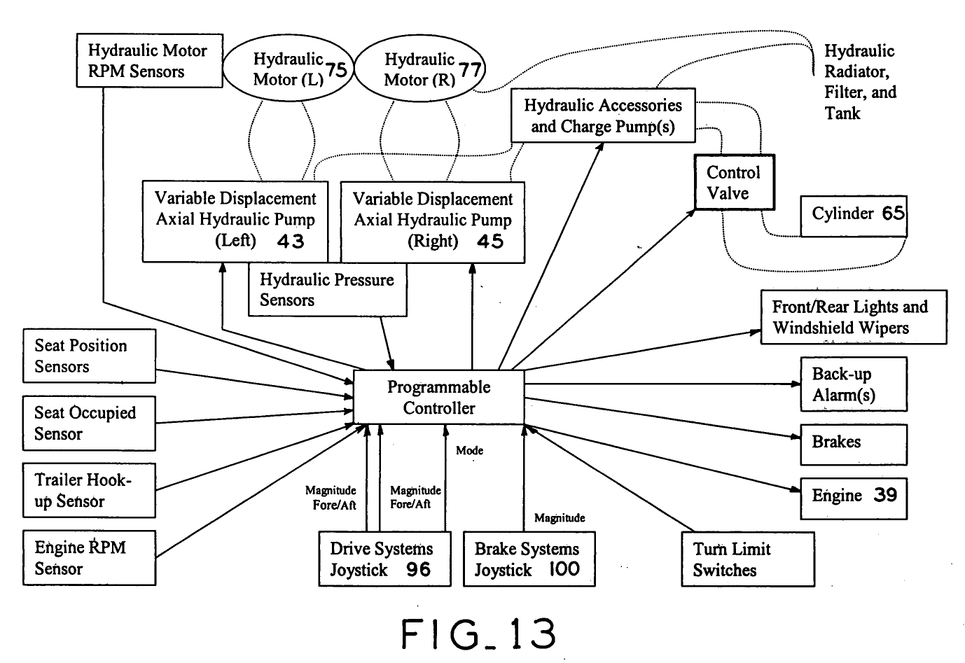

As discussed above, the trailer spotter of the present invention, in one embodiment, includes a control console, a differential drive system, and a programmable controller. As described above, the control console includes, among other things, joystick controller 96 for guiding the trailer spotter. Joystick controller 96 converts the mechanical movement of the joystick handle into electrical signals which are transmitted to the controller via, for example, a wiring harness. In other embodiments, to avoid twisting the wiring harness when seat portion 78 is turned, a rotating union between base portion 76 and seat portion 78 may be utilized to main communication between the control console and controller. In either event, in order to process these signals, the controller is programmed with a set of instructions which determine the output response to be conveyed to the differential drive system in view of the input signals. For example, if the joystick is moved to the right, the controller may be programmed to instruct the differential drive system to turn the trailer spotter to the right. In fact, referring to FIG. 13, the programmable controller, in the present embodiment, is configured to receive all of the inputs from the control console and produce output signals to the peripheral devices of the trailer spotter, such as, for example, back-up alarms, wipers, lights, etc. Further, the controller may include several sets of instructions which, depending on certain parameters, operate the trailer spotter in different ways. The controller of the present embodiment includes three sets of instructions for three basic drive conditions of the trailer spotter, i.e., a first set of instructions for driving the trailer spotter in a forward direction, a second set of instructions for driving the trailer spotter in a reverse direction, and a third set of instructions for pivoting the trailer spotter about an axis.

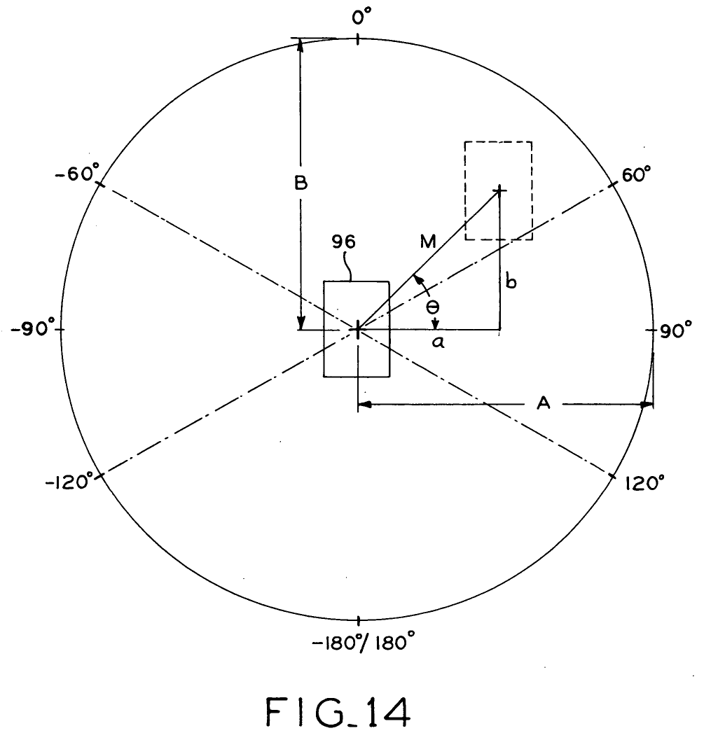

Referring to FIG. 14, the movement of the joystick handle is measured, as known in the art, by a plurality of sensors surrounding the joystick handle in the joystick base. These sensors detect the proximity of the joystick handle with respect to the sensors and convey this information to the controller. More particularly, the sensors detect the distance and direction that the joystick handle has been displaced with respect to the center, or datum, position of the joystick handle. The center position of the joystick handle is represented by the solid outline in FIG. 14 while a displaced position of the joystick handle is represented by the dashed outline. The magnitude of the joystick handle displacement is represented by the Cartesian co-ordinates a and b, which represent the magnitude of the joystick handle displacement in the lateral and forward/rearward directions, respectively. These co-ordinates, when received by the controller, are converted into polar co-ordinates represented by magnitude M and angle Θ. More specifically, the controller, based on inputs a and b, calculates a value for angle Θ between +180° and −180° (FIG. 14) and a value for the magnitude M between ±A or ±B (FIG. 14), which represent the physical limits of the joystick handle in the lateral and forward/rearward directions, respectively.

After the controller has determined values for M and Θ for the position of the joystick handle, these values are inserted into the following equations, for example, which determine the appropriate angles for the swashplates of pumps 43 and 45:
Left swashplate (pump 43) M/A×P×[cos((Θ/2−Φ)/2))]^{1/2}
Right swashplate (pump 45) M/A×P×[sin((Θ/2−Φ)/2))]^{1/2}
where M=(a²+b²)^{1/2}, i.e., the magnitude of joystick deflection, A=the maximum magnitude of joystick deflection, i.e., ±A in the forward and aft directions and ±B in lateral directions, as described above, and P=the maximum swashplate angle. In effect, when M=A, i.e., when the joystick handle has been displaced its maximum value, the trailer spotter will be driven at its maximum speed in the direction determined by [cos((Θ/2−Φ)/2))]^{1/2} and [sin((Θ/2−Φ)/2))]^{1/2}, where Θ=arctan(a/b), i.e., the angle of joystick deflection, and Φ=a phase shift angle for shifting the trigonometric functions so that they produce a desired value. For example, when the joystick handle is placed in the 90° position, i.e., a full right turn, Θ=90° and shift angle Φ equals a value such that cos((Θ/2−Θ)/2)) is brought to its maximum value and sin((Θ/2−Φ)/2)) is brought to zero. Accordingly, the swashplate of pump 43 is positioned at its maximum angle with respect to its neutral datum to drive left rear wheels 38 at their maximum speed while the swashplate of pump 45 is brought into its neutral position so as to not drive right rear wheels 40, thereby effecting a full right turn.

The exemplary equations described above include trigonometric functions which provide for smooth transitions between joystick control points. Further, by taking the square root of the sine and cosine functions, the response curves are smoother, thereby preventing abrupt movements in the trailer spotter. Notably, to use these trigonometric equations, the formulas may need to be modified such that the absolute values of the trigonometric functions are used when performing the square root in order to prevent the calculation of irrational numbers. Other non-trigonometric drive equations can be utilized, including linear equations. However, in one exemplary embodiment, the operator is located up to ten feet from the center of rotation of the trailer spotter and, as a result, the linear speed control inputs may result in a somewhat jerky ride.

Notably, the exemplary equations described above were simplified to describe the basic steering concept for the trailer spotter when the operator's seat is facing in the forward position (FIG. 9). However, as described above, the operator's seat can be turned 180 degrees to face the rear of the vehicle. As a result, the operator's perception of left and right will have changed, making the operation of the trailer spotter somewhat confusing and counterintuitive. To compensate for this, the basic drive equations described above can be modified to:
Left swashplate (pump 43) M/A×P×D×[cos((Θ/2−Φ)/2))]^{1/2}
Right swashplate (pump 45) M/A×P×D×[sin((Θ/2−Φ)/2))]^{1/2}
where D is a direction correction factor that is +1 when the operator's seat is facing forward and −1 when the operator's seat is facing rearward, for example. When D=−1, each swashplate is tilted in an opposite direction than when D=+1 to drive hydraulic pumps 43 and 45 in reverse. In order for the controller to know whether the operator's chair is facing forward or rearward, the chair can include proximity sensors, for example. More particularly, referring to FIG. 11, base portion 76′ can include a first sensor positioned in the front and a second sensor positioned in the rear and seat portion 78′ can include a metal member projecting therefrom. In use, the sensors can detect the proximity of the metal member projecting from seat portion 78′, or lack thereof, and transmit that information to the controller so that the correct value for D may be inserted into the equations. In alternative embodiment, limit switches may be used to detect the position of the chair.

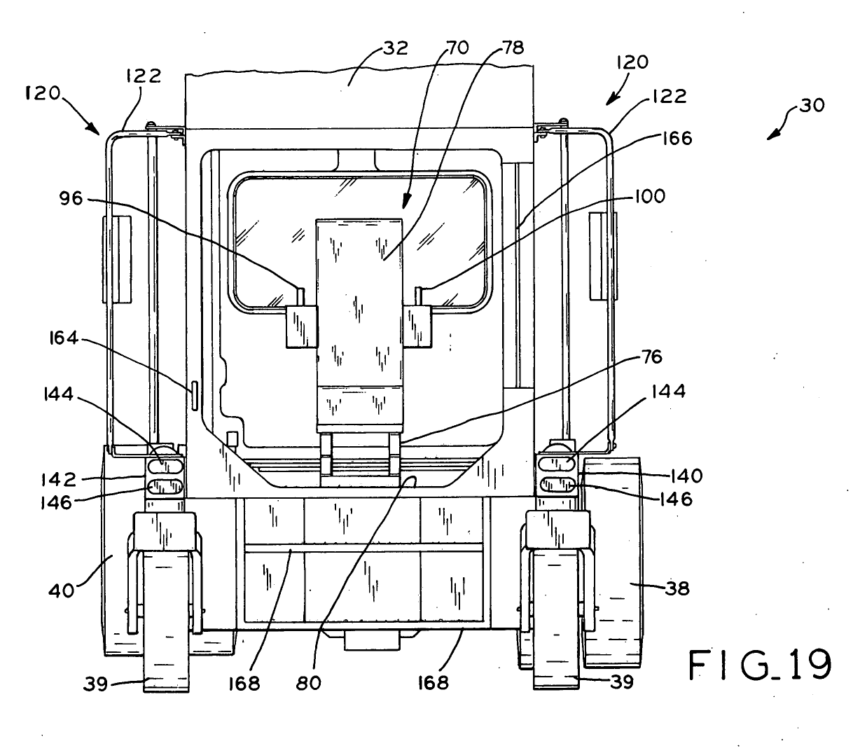

The value of the D variable can also be used to determine whether the lights in the front and the rear of the vehicle are headlights or brakelights. More specifically, referring to FIG. 19, the front of the vehicle includes lights banks 140 and 142 which each include a white light 144 and a red light 146. When the operator's seat is facing forward and the D variable equals +1, for example, the programmable controller instructs light banks 140 and 142 to operate white lights 144 as headlights and to deactivate red lights 146. Similarly, referring to FIG. 4, the rear of trailer spotter 30 includes light banks 148 and 150 which both have a white light 144 and a red light 146. When the seat is in the forward position, the controller instructs light banks 148 and 150 to operate the red lights 146 as brakelights and to deactivate the white lights. However, when the operator's seat is facing the rear, and the D variable equals −1, for example, the instructions for light banks 140, 142, 148 and 150 are reversed. For example, in this condition, the front light banks 140 and 142 are instructed by the controller to operate red lights 146 as brakelights and to deactivate white lights 144. Accordingly, by reversing the lights as described above, people working around the vehicle will not be deceived by the brakelights, for example, being on the wrong side of the vehicle.

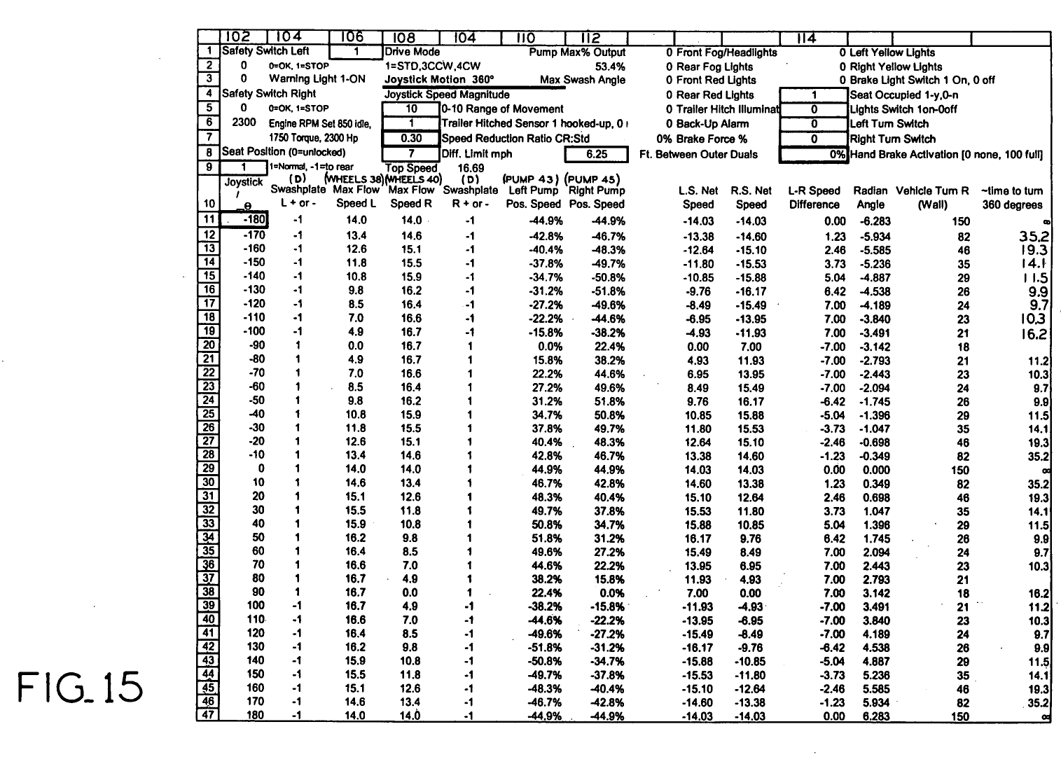

Referring to FIG. 15, a table is provided, for one embodiment, which illustrates the relationship between the position of the joystick handle, the output of pumps 43 and 45, and the speed of the left and right wheels, respectively. For example, referring to column 102, lines 11-47, the range of angle Θ, i.e., the angle of the joystick handle, is listed in 10 degree increments between −180° and +180°. For each 10 degree increment, the output of left pump 43 and right pump 45 is listed in columns 110 and 112, respectively, where the maximum output of each pump is limited to, in this example, 53.4%. Further, for each 10 degree increment, the corresponding theoretical wheel speed of left rear wheels 38 and right rear wheels 40 is calculated in columns 106 and 108, respectively. However, even though these wheel speeds are achievable, they may not be desirable as an excessive relative difference in wheel speeds may cause the trailer spotter to become unstable and more susceptible to tipping over. Accordingly, referring to column 14, lines 11-47, the relative difference in wheel speeds is calculated and, in this embodiment, is limited to 7 mph. Thus, once the maximum permitted relative wheel speed is achieved, the swashplates of pumps 43 and 45 are not permitted to be displaced into a greater tilt by the programmable controller. Accordingly, to account for this, the drive equations of the trailer spotter can be modified to:
Left swashplate M/A×P×D×[sin((Θ/2−Φ)/2))]^{1/2}−SD/TS
Right swashplate M/A×P×D×[cos((Θ/2−Φ)/2))]^{1/2}−SD/TS
where SD=the speed differential allowable between rear wheels 38 and 40 (mph), and TS=the designed vehicle top speed (mph). Notably, for the embodiment described in FIG. 15, the relative speed between left rear wheels 38 and right rear wheels 40 is limited when the joystick handle is between the ranges of +60° and +120° and −60° and −120° (FIG. 14).

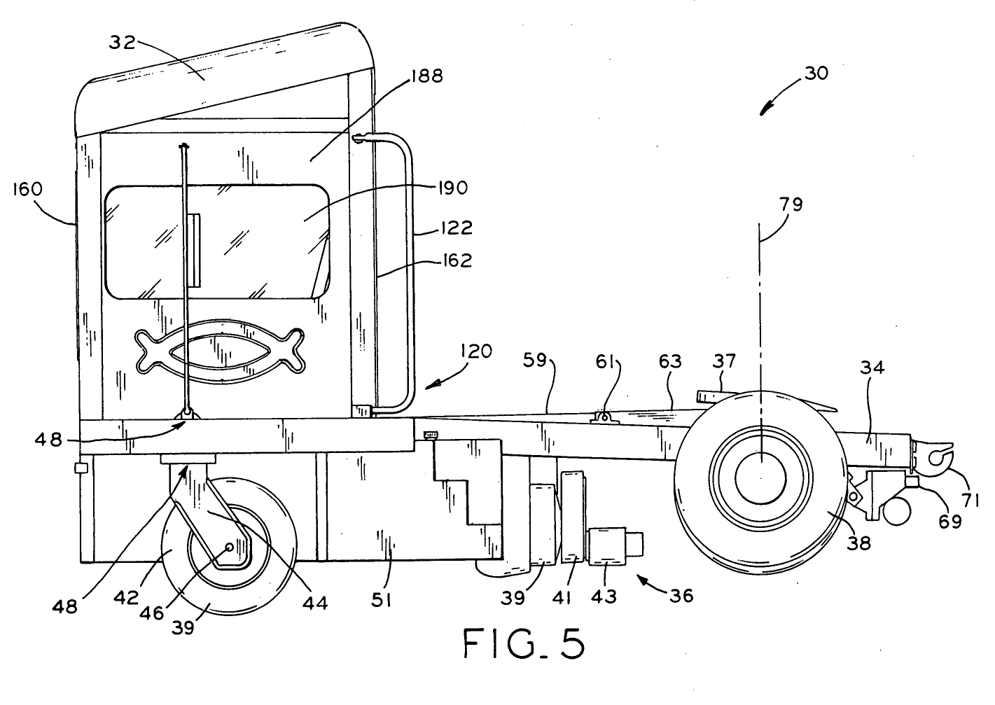

Referring to FIGS. 4 and 5, and as described above, the trailer spotter can be turned about axis 79 when left rear wheels 38 and right rear wheels 40 are differentially driven in opposite directions. Also discussed above, the programmable controller includes a third set of instructions for pivoting the trailer spotter about the axis. The drive equations for this condition are:
Left swashplate: SRR×D×M/A
Right swashplate: SRR×D×M/A
where SRR=the speed reduction ratio. The speed reduction ratio (SRR) represents the fraction of the maximum speed that the wheels are actually permitted to turn. More particularly, as a result of the pivoting motion, the turning speed of the trailer spotter can be much faster in this condition than in the other two conditions and, as a result, the maximum actual drive speed can be reduced via this correction factor. Reducing the turning speed may allow the operator to better and more safely control the vehicle.

Further safety controls can be implemented which cause the D variable in the drive equations to become zero, thereby forcing one or both of the swashplates into their neutral positions. For example, the operator's seat can include a sensor, such as a weight sensor, for example, for detecting the presence of the operator in the seat. When the sensor does not detect an operator in the seat, the D variable is set to zero for both the left and right swashplates causing the swashplates to be positioned in their neutral positions, thereby rendering pumps 43 and 45 incapable of driving rear wheels 38 and 40. Accordingly, rear wheels 38 and 40 cannot be driven by the hydraulic drive train when an operator is not seated in the chair. Similarly, the trailer spotter can further include an engine RPM sensor in communication with the programmable controller. When the speed of the trailer spotter engine is outside of a desirable range, the controller can set the D variable in the above equations to zero to prevent the rear wheels from being driven. Further, an emergency breaking feature can be utilized where, when a switch is activated, or deactivated, the programmable controller sets the D variable to zero.

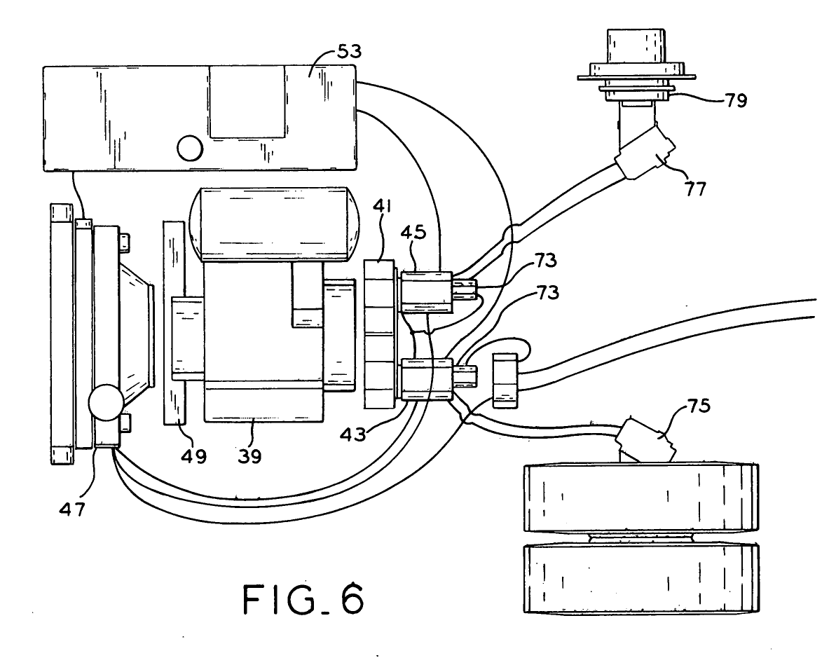

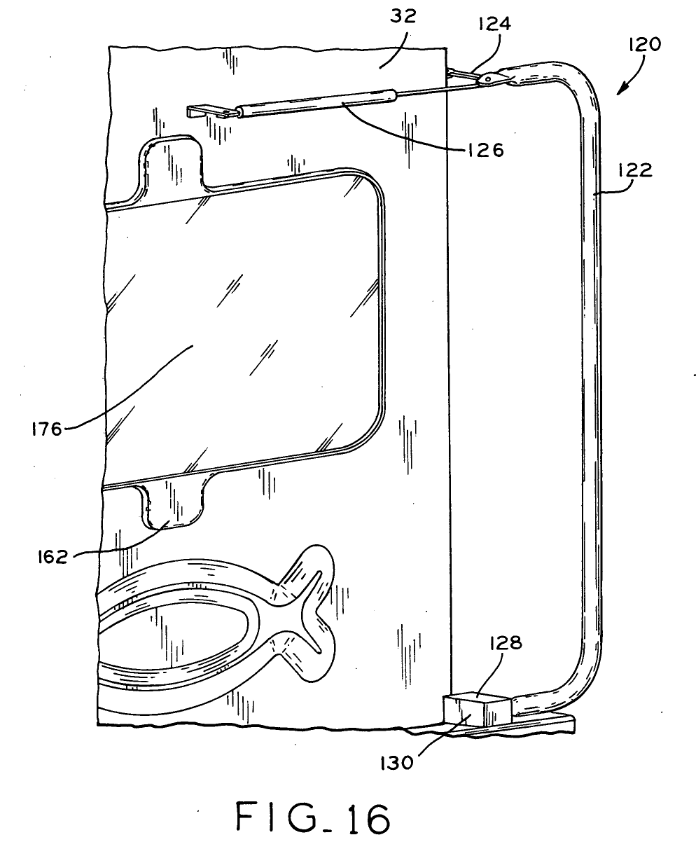

Trailer spotter 30 includes an additional safety feature which assists in preventing a trailer from jack-knifing with respect to the trailer spotter. Referring to FIGS. 16-18, anti-jackknifing assemblies 120 each include a grab handle 122 mounted to cab 32 at its first and second ends. At their first ends, each grab handle 122 is mounted to cab 32 via a connecting link 124 and spring 126. The second ends of grab handles 122 are mounted within switch boxes 128. In use, grab handles 122 are held in a substantially stationary position, however, when the trailer spotter turns with respect to the trailer, the trailer may contact and rotate one of grab handles 122. In this event, the second end of the grab handle 122 will rotate away from limit switch 130 in switch box 128 which causes switch 130 to transmit a signal to the programmable controller to stop the trailer spotter. In the present embodiment, when the sensor is tripped, i.e., when the turn limit circuit is interrupted, the programmable controller will cut hydraulic fluid flows to wheel motors 75 and 77 (FIG. 6) so that the trailer spotter cannot be further turned in that direction. However, the trailer spotter can be turned in the opposite direction to maneuver the trailer spotter away from the jack-knife condition. More particularly, in the present embodiment, when switch 130 has been tripped, the D variables of the drive equations discussed above can be limited to values which set the swashplates in pumps 43 and 45 to their neutral position and/or limit the D variables to either +1 or −1, depending on the circumstances. For example, a break in the circuitry at the right turn limiter would prevent the left pump, i.e., pump 43, from driving forward and the right pump, i.e., pump 45, from driving backwards. As a result of the above, the driver could negotiate the vehicle out of the jackknife condition with the trailer but could not drive further into trouble.

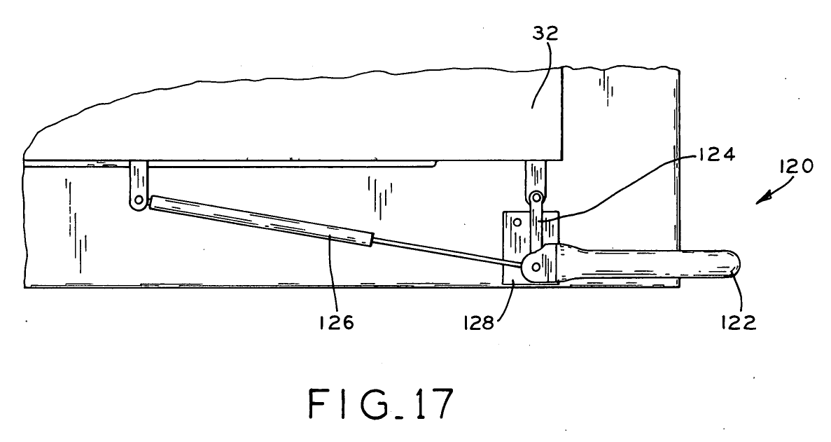

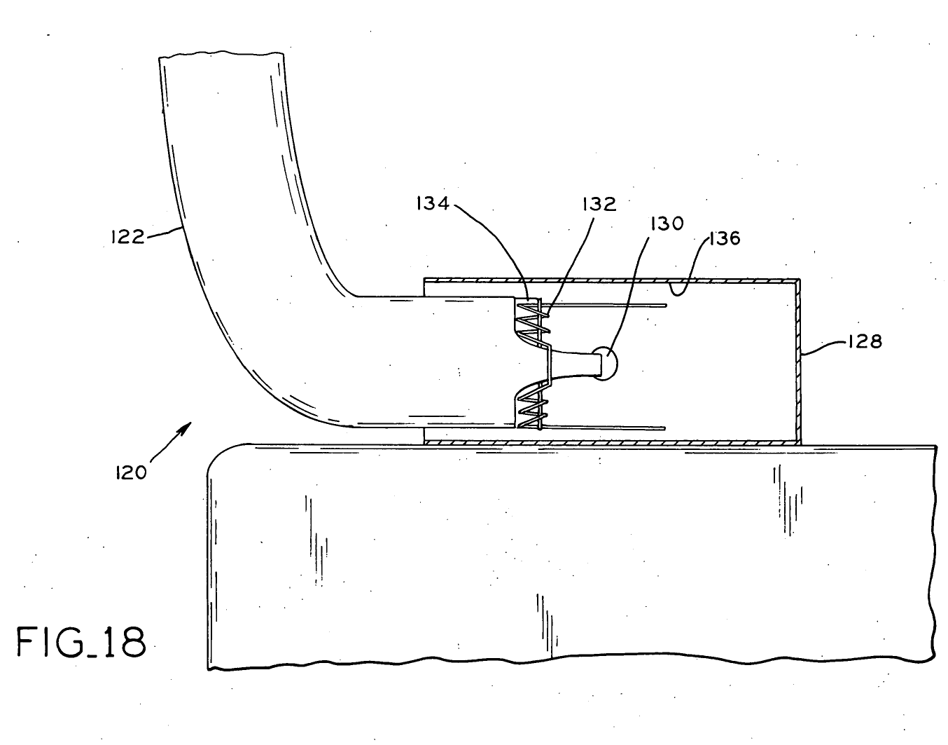

Referring to FIG. 18, limit switch 130 includes a roller (not illustrated) that is biased against a cam profile on the second end of grab handle 122. After grab handle 122 has been displaced by the trailer, the roller of switch 130 will move into a range of positions which indicate that the trailer spotter and the trailer may be in a jackknifing condition. Once the direction of the trailer spotter has been corrected, and grab handle 122 is no longer rotated by the trailer, torsion spring 132 in switch box 128 will bias grab handle 122 back into its original position (FIGS. 16 and 17). Further, in the event that grab handle 122 is significantly displaced, the connection between link 124, spring 126 and grab handle 122 includes a spherical bearing that permits grab handle 122 to pivot about the lower connection in switch box 128. The orientation of the first end of grab handle 122 in switch box 128 is maintained by spacer 134 which remains in a substantially vertical position within cavity 136. In addition, pneumatic spring 126 resiliently permits large movements of grab handle 122 and assists in preventing damage to either handle 122 or its connections to the trailer.

Although placing the swashplates of hydraulic pumps 43 and 45 in a neutral position, as described above, can provide a significant amount of braking for the trailer spotter, the trailer spotter can be equipped with both a parking brake and a service brake. To keep the vehicle stationary, the parking brake can be automatically engaged whenever the vehicle is turned off and/or when the operator's seat is unoccupied. More particularly, in the present embodiment, the parking brake is engaged with a brake rotor mounted to the wheel axle when the programmable controller receives a signal from the engine sensor that the engine RPM is substantially zero and/or the seat sensor indicates that an operator is not sitting in the seat. In other embodiments, the parking brake can be a traditional parking brake than is manually activated.

Further, in the present embodiment, the service brake can be integrated with the control system such that it is either engaged manually by the movement of brake joystick 100 or automatically by the turn limit system including anti-jackknifing system 120, as described above. The forces applied by the service brake can be proportional to the magnitude of the deflection of brake joystick 100 with respect to its center position, similar to joystick 96 described above. However, in the present embodiment, only the magnitude of the joystick deflection is used in determining the braking force. As a result, the operator can push or pull in any direction to apply the brake. However, in other embodiments, the direction of the brake joystick deflection can be used by the controller to apply different braking forces to the different wheels of the trailer spotter. In an alternative embodiment, an operator can twist the brake joystick to add or decrease braking forces to one side of the tractor's brakes. This would enable some differential/skid steering for the hydraulic drive system especially when the system is in an overrun condition or going downhill. In addition, by utilizing the programmable controller in the brake system, the controller can be programmed to allow the drive and brake joysticks to be swapped based on the operator's preference for having the drive joystick, for example, on their left or right side.

Once the controller has received a signal to activate the service brake, the controller can output signals to brake assemblies associated with one or more of the trailer spotter wheels. These brake assemblies can be configured to engage brake rotors, for example, mounted to the wheel axles when they are activated. In one embodiment, the output signals of the controller are communicated to a conventional hydraulic brake system which moves one or more calipers with respect to the wheel rotors, for example. In another example, the output signals of the controller can be communicated to brake calipers driven by electric motors.

In addition, when anti-jackknifing system 120 detects a jackknife condition, i.e., when grab handle 122 has been sufficiently displaced, in the present embodiment, the controller can command maximum stopping forces to all of the brakes. In order to disengage the brakes, the controller can be programmed to release the brakes when the trailer spotter vehicle is driven in the substantially opposite direction, i.e., driven out of the jackknife condition. Stated in another way, in this embodiment, if the joysticks are positioned such that the corresponding movement would worsen the hazard, the brakes will remain locked.

Additionally, to improve safety conditions, the trailer spotter can include a switch which detects whether a trailer is attached to the trailer spotter. When a trailer is attached, the sensor sends a signal to the programmable controller which, in turn, activates a back-up alarm to indicate that the trailer spotter and trailer are moving backward. Further, inputs from the trailer sensor can be used by the controller to provide outputs which are different when a trailer is not attached to the trailer spotter. For example, the magnitude of the swashplate angles can be increased to provide additional power to pull the trailer when the controller and switch perceive an attached trailer. Further, when the controller and sensor detect an absence of a trailer, the engine RPM can be set at a lower horsepower level to conserve fuel. Additional control system parameters may be used to adjust the rate of change of hydraulic fluid flow, i.e., vehicle acceleration, to prevent system damage or engine overload conditions, or to optimize performance by using system pressure measurements to effectively adjust for trailer weights.

Referring to FIGS. 4, 5 and 19, cab 32 of trailer spotter 30 includes front door 160 and rear door 162. In use, an operator can enter cab 32 from either front door 160 or rear door 162. To enter from the front of cab 32, the operator opens door 160 using latch 164 on the right side of the vehicle. The door (removed from FIG. 19) swings on hinges 166 at the edge of door 160 on the left side of the vehicle. Trailer spotter 30 further includes ladder-style steps 168 mounted to the front of cab 32 to assist the operator when entering into cab 32. Notably, in this embodiment, there are no controls of trailer spotter 30 in the front of cab 32 that obstruct the operator's entry therein. Rather, the controls of trailer spotter 30, in this embodiment, are mounted to seat 70. Further, in the present embodiment, the seat may be facing either forward or aft without interfering or endangering the operator as there is approximately 28 inches of clear floor standing room between the edge of seat 70 and the doorway where the operator can turn around and close door 160 before sitting down. Similar clearance space exists between the armrest displays of seat 70 and side walls of cab 32 providing access to seat 70 if it is facing rearward. In an alternative embodiment, a powered chair positioning system could be installed to unlatch and swing the seat to face the front door when it is opened so that the operator does not have to slide along the side of chair 70 when entering from the front door and the chair is facing the rear. The chair positioning system could also turn the chair to face the rear when the rear door is opened.

To enter cab 32 through rear door 162, the operator climbs rear stairs 170 or 172 onto engine cover 59 and slides rear door 162 into the interior of cab 32. As illustrated in FIGS. 4 and 5, steps 170 are formed into gas tank 51 and steps 172 are formed into hydraulic fluid reservoir 53. Latch handles 174 of rear door 162 are located in the center of the door, just below rear window 176. Pull/push rods (not illustrated) transmit the required opening action to latches (not illustrated) on the right edge of the door. When unlatched, rear door 162 initially translates inward and then left and forward as rear cam followers 180 follow tracks in guide rails 182 mounted on rear wall 184 and left cam follower 178 follows guide rail 186 mounted on left side wall 188. A storage position latch (not illustrated) is positioned at the end of door travel to hold the door, enabling the operator to minimize efforts to store the door. Notably, rear window 176 of rear door 162 is sized and configured such that when rear door 162 is positioned substantially parallel with side wall 188, rear window 176 substantially overlaps side window 190 so that rear door 162 does not obstruct an operator's view through side window 190 from seat 70. In fact, in the illustrated embodiment, all of the windows in the four sides of the cab are substantially the same size.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A trailer spotter vehicle, comprising:
a frame;
a first wheel and a second wheel mounted to said frame;
at least one motor for driving said first wheel and said second wheel, said at least one motor capable of simultaneously rotating said first wheel in a first direction and rotating said second wheel in an opposite direction to thereby turn the vehicle;
a seat; and
a control console, wherein said seat and said control console are rotatably mounted to said frame, whereby said seat and said control console may be rotated with respect to said frame.

2. The trailer spotter vehicle of claim 1, further including a mount for connecting the trailer spotter vehicle to a trailer, the trailer rotatable with respect to the trailer spotter vehicle about a first axis, said first wheel having an axis of rotation substantially collinear with an axis of rotation of said second wheel along a second axis, and wherein said first axis is substantially perpendicular to said second axis.

3. The trailer spotter vehicle of claim 1, wherein said motor is capable of rotating at least one of said first wheel and said second wheel in said first direction to propel the vehicle forward and rotating at least one of said first wheel and said second wheel in said opposite direction to propel the vehicle backward.

4. The trailer spotter vehicle of claim 3, wherein said seat and said console are rotatable about an axis between first and second orientations, whereby said first orientation allows the operator to observe the path of the vehicle when it is moving forward and whereby said second orientation allows the operator to observe the path of the vehicle when it is moving backward.

5. The trailer spotter vehicle of claim 1, further including a manual input device for controlling the path of the vehicle, and a controller which is operably engaged with the manual input device to receive input from the manual input device and is operably engaged with the first and second wheels to output a first set of instructions to the first and second wheels when the chair and control console are in a first orientation and output a reverse set of instructions to the first and second wheels when the chair and control console are in a second orientation.

6. The trailer spotter vehicle of claim 5, further including a limit switch which is tripped when said seat is moved into one of said first and second orientations, said limit switch operably connected to said controller to instruct the controller to output either said first set of instructions or said reverse set of instructions.

7. A trailer spotter vehicle, comprising:
a frame;
a first wheel and a second wheel;
at least one motor for driving said first wheel and said second wheel;
a first sensor for sensing the speed of said first wheel;
a second sensor for sensing the speed of said second wheel;
a controller for comparing the speeds of said first wheel and said second wheel and for limiting the speed of at least one of said first wheel and said second wheel if the relative difference between the speeds of said first wheel and said second wheel exceeds a pre-determined value.

8. The trailer spotter vehicle of claim 7, wherein said at least one motor is capable of rotating said first wheel in a first direction and rotating said second wheel in an opposite direction to thereby turn the vehicle.

9. A trailer spotter vehicle, comprising:
a frame having a mount for connecting a trailer to the vehicle wherein the trailer is relatively rotatable with respect to the vehicle about said mount;
a motor mounted to the frame for motivating the vehicle;
at least one ground-engaging wheel operably engaged with the motor, said at least one wheel rotatable in first and second directions by said motor;
an actuator mounted to the frame, said actuator positioned on said frame so that when the relative rotational movement between the vehicle and the trailer exceeds a pre-determined value, said motor is substantially prevented from rotating said at least one ground-engaging wheel in one of said first and second directions, whereby the vehicle and the trailer cannot jackknife.

10. The trailer spotter vehicle of claim 9, further comprising a limit switch, said actuator comprising a bar extending from the vehicle via a hinge, wherein contact between the trailer and said bar pivots said bar about said hinge, wherein sufficient movement of said bar trips said limit switch, and wherein said limit switch is operably engaged with said motor to prevent said motor from rotating said ground-engaging wheel in one of said first and second directions when said limit switch is tripped.
